(19) United States
(12) Patent Application Publication
(10) Pub. No.: US 2010/0147763 A1
(43) Pub. Date: Jun. 17, 2010

(54) MODIFIED POROUS MEMBRANES, METHODS OF MEMBRANE PORE MODIFICATION, AND METHODS OF USE THEREOF

(75) Inventors: Dean T. Tsou, Bedford, MA (US); Manuel M. Pacheco, Billerica, MA (US)

Correspondence Address: EDWARDS ANGELL PALMER & DODGE LLP, P.O. BOX 55874, BOSTON, MA, 02205, US

(73) Assignee: Whatman, Inc., Florham Park, NJ (US)

(21) Appl. No.: 12/449,097

(22) PCT Filed: Jan. 23, 2008
(86) PCT No.: PCT/US2008/000921

§ 371 Date: Feb. 12, 2010

Related U.S. Application Data
(60) Provisional application No. 60/897,400, filed on Jan. 24, 2007.

(51) Int. Cl. B01D 71/00; B01D 61/18; B01D 67/00; C08F 14/22

(52) U.S. Cl. 210/500.21; 521/145

(57) ABSTRACT

The present invention describes a method of modifying pores of a porous membrane, comprising contacting the membrane with a pore modifying agent, wherein the pore modifying agent modifies the pore opening at the first surface of the membrane differently than the pore opening at the second surface of the membrane. The invention also describes a porous membrane having a first surface and a second surface, comprising a plurality of pores extending between the first and second surfaces, wherein the pores have been modified by a pore modifying agent such that the pore opening at one membrane surfaces is distinct from the pore opening of the other membrane surface, or the pore shape is distinct at one or more locations between the first and second surfaces.

### RELATED SUBJECT MATTER

This application claims the benefit of U.S. provisional patent application Ser. No. 60/897,400, filed on Jan. 24, 2007. The disclosure of the aforementioned patent application is incorporated herein in its entirety by this reference.

### TECHNICAL FIELD

The present invention relates generally to modified porous membranes, methods for membrane pore modification, and methods of use.

### BACKGROUND

Synthetic membranes are used for a variety of applications including desalination, gas separation, filtration and dialysis. The properties of the membranes vary depending on the morphology of the membrane, i.e., properties such as symmetry, pore shape and pore size and the polymeric material used to form the membrane.

Different membranes can be used for specific separation processes, including microfiltration, ultrafiltration and reverse osmosis. Microfiltration and ultrafiltration are pressure driven processes and are distinguished by the size of the particle or molecule that the membrane is capable of retaining or passing. Microfiltration can remove very fine colloidal particles in the micrometer and submicrometer range. As a general rule, microfiltration can filter particles down to 0.1 μm, whereas ultrafiltration can pass through particles as small as 0.01 μm. Reverse osmosis operates on an even smaller scale.

As the size of the particles to be separated increases so too does the pressure required to carry out the separation and the density of the membrane. Many of the polymers that porous membranes are made of are hydrophobic. Water can be forced through a hydrophobic membrane by use of sufficient pressure, but the pressure needed is very high (150-300 psi), and the membrane may be damaged at such pressures and generally does not become wetted evenly.

Microporous membranes act as screens or sieves and retain on their surface all particles larger than the given width of a channel (i.e. pore diameter). Entrapment on the membrane surface of particles of approximately the pore diameter will rapidly plug the membrane irreversibly, leading to rapid decline in flow rate. Due to the tortuous nature of the flow channels in conventional microporous membranes, significant hydraulic pressure is needed to force liquids from one side of the membrane to the other. As the membranes clog, this pressure necessarily increases.

Hydrophobic microporous membranes are characterised by their excellent chemical resistance, biocompatibility, mechanical strength and separation performance. Thus, in the application of water filtration, such hydrophobic membranes need to be made hydrophilic to allow water to permeate them. In many applications of filtration technology, it is desirable to utilize a membrane filter which is mechanically strong, is thermally stable, is relatively inert chemically and is insoluble in most organic solvents. Often, it is desirable that the membrane have surface properties which are radically different from, and sometimes incompatible with the bulk properties set forth above. Desirable surface properties include wettability, low protein adsorbing tendency, thromborestivity, controlled ion exchange capacity and controlled surface chemical reactivity.

Modification of a polymer's surface potentially can maintain a polymer's desirable bulk properties but can provide new, different interfacial properties. Membranes made from hydrophilic polymers are generally less prone to fouling than hydrophobic polymers. In some instances, surface modification of more chemically resistant polymers has rendered them less susceptible to fouling. Numerous techniques exist for the surface modification of polymers. The most common examples of this chemistry are reactions that introduce a single type of functional group or mixture of functional groups.

In general, techniques of hydrophilization of polymer surfaces involve an increase of the surface amount of polar groups. From a microscopic point of view, the basis of surface hydrophilization is to maximize hydration and hydrogen bonding interactions. Oxygen, nitrogen or sulfur containing organic functional groups can interact with water more effectively than common carbon based repeating units. There are various methods for wetting a membrane on a non-permanent basis. One method of hydrophilizing a porous hydrophobic membrane has been to pass alcohol through the pores of the membrane, then replace the alcohol by water. Surfactants and a post treatment with a glycerol coating have also been used. However, if the water is removed from the pores either wholly or partially, and they are filled with air, the hydrophilized membrane is rendered hydrophobic again, and water cannot pass through the pores if it is not subjected to high pressure.

Another method to render the hydrophobic membranes hydrophilic, and thereby usable for the filtration of aqueous solutions, is to utilize a wetting agent which can be added to the polymeric system used to cast the membrane. The wetting agent, which is a surface active agent, can be applied to the membrane matrix in a post-production treatment step. One method of addressing the leaching problem associated with wetting agents involves using a polymeric wetting agent, crosslinked during the post-treatment step onto the membrane matrix (e.g., U.S. Pat. No. 5,376,274).

Attempts at solving the leaching problem encountered with hydrophobic membranes rendered hydrophilic by the addition of a wetting agent involved the use of a block copolymer as a matrix additive, the copolymer comprising a combination of hydrophobic and hydrophilic portions. The hydrophobic portion of the copolymer additive, being more compatible with the hydrophobic matrix polymer, tends to tangle with and thus become anchored to the membrane matrix polymer, leaving the hydrophilic portion of the copolymer at the membrane surface. The interaction between the main hydrophobic matrix membrane, the block copolymer additive and the solvent system used for the formulation is a complicated one. Variations in the type and amount of the various components of the system as a whole may cause more or less entanglement of the block copolymer with the membrane matrix and thereby affect the hydrophilicity of the membrane. While the addition of a block copolymer wetting agent improves over other prior art methods noted above, it nonetheless suffers, even slightly, from problems related to the amount of agent actually retained at the membrane surface.

Polyvinylidene fluoride microporous membranes, generally formed as thin sheets of substantially uniform thickness, have a sponge-like internal structure containing millions of channels. These channels define a tortuous flow path for liquids from one side of the membrane sheet to the other side. Conventional methods of producing these polyvinylidene fluoride (hereinafter “PVDF”) membranes result in membranes having a matrix of intercommunicating channels, the channels having a substantially uniform width within narrow limits.

Conventionally-produced PVDF membranes are commercially available with average pore sizes (i.e. pore diameters) in the range from about 0.10 μm to about 5.0 μm. Attempts to produce microporous membrane filters having pore sizes less than about 0.10 μm have generally led to problems of very slow flow because of the small pore size, and to problems of rapid plugging.

Such conventionally-produced PVDF membranes are disclosed by Mahoney, in U.S. Pat. No. 5,013,339. The reference describes a composition used in preparing microporous PVDF polymer membranes. The average pore size of the microporous membranes described in the reference is from about 0.05 μm to about 10.0 μm. The reference further describes that the membranes produced are used for liquid separation processes such as microfiltration, ultrafiltration, dialysis, and membrane stripping. It is noted that ultrafiltration and microfiltration are pressure driven processes using porous membranes in which particles or solutes are separated from solutions. The membranes may be characterized by their hydraulic permeability and sieving coefficient. Hydraulic permeability is defined as a flow rate, such as gallons/ft²/day (GFD) at a given pressure. More specifically, hydraulic permeability is defined as the volume of a solvent transported through the membrane under the influence of a pressure gradient.

Thus, there are deficiencies associated with current methods available for the modification of membrane pores, including modification of membrane pore characteristics for the purposes of filtration.

### SUMMARY OF THE INVENTION

The invention relates to a method of chemically and/or physically modifying the pores of a porous substrate. In certain embodiments, the invention is directed to modifying the shape of a pore in a porous substrate/membrane. In certain embodiments the substrate is in the form of a membrane, a filter, a film, a web, a mesh, a fabric, a matrix, a swab, a column packing material, or gradient filter. As described herein, the substrates are in the form of a porous membrane. However, the particular form or use of the substrate is not intended to be a limiting aspect of the invention, and any type of substrate is within the scope of the invention.

In one aspect, the invention provides a method of modifying pores in a porous membrane, the porous membrane comprising pores bridging a first surface and a second surface, the method comprising: contacting the membrane pores with a pore modifying agent; wherein the pore modifying agent modifies the pores at the first surface of the membrane differently than the pores at the second surface of the membrane.

In another aspect, the invention provides a method of modifying pores in a porous membrane, the porous membrane comprising pores bridging a first surface and a second surface, the method comprising: contacting the membrane pores with a pore modifying agent; wherein the pore modifying agent contacts the pores at the first surface of the membrane at a different concentration than the pores at the second surface of the membrane.

In one aspect, the invention provides a porous membrane having a first surface and a second surface, comprising a plurality of pores extending between the first and second surfaces, wherein the pores have been modified by a pore modifying agent such that the pore diameter at one or both membrane surfaces is distinct from the pore diameter at one or more locations between the first and second surfaces.

The instant invention provides the novel method of modifying pores of a porous membranes wherein the two ends of the pores are modified to different extents, due to the exposure of each side of the membrane to a pore modifying agent.

Other aspects and advantages of the invention will become apparent from the following description, taken in conjunction with the accompanying drawings, illustrating the principles of the invention by way of example only.

### BRIEF DESCRIPTION OF THE DRAWINGS

FIG. 1A shows a schematic representation of a porous membrane in contact with a drum with drain holes.

FIG. 1B shows a cross section of a drum wherein a membrane completely covers the drain holes of the drum.

FIG. 1C shows a cross section of a drum wherein a membrane partially covers the drain holes of the drum.

### DETAILED DESCRIPTION

### Membrane Modification

In one aspect, the invention provides a method of modifying pores in a porous membrane, the porous membrane comprising pores bridging a first surface and a second surface, the method comprising: contacting the membrane pores with a pore modifying agent; wherein the pore modifying agent modifies the pores at the first surface of the membrane differently than the pores at the second surface of the membrane.

In another aspect, the invention provides a method of modifying pores in a porous membrane, the porous membrane comprising pores bridging a first surface and a second surface, the method comprising: contacting the membrane pores with a pore modifying agent; wherein the pore modifying agent contacts the pores at the first surface of the membrane at a different concentration than the pores at the second surface of the membrane.

In one embodiment, the invention provides a method, wherein the pore modifying agent contacts the pores at the first surface of the membrane at a different concentration than the pores at the second surface of the membrane.

In certain embodiments, the invention provides a method further comprising the step of disposing the membrane on or about a porous drum with the first surface engaging the drum, then contacting the pore modifying agent with the second surface of the membrane.

In another embodiment, the invention provides a method further comprising the step of detaching the membrane from the drum, disposing the membrane on one or more further porous drums, and contacting the membrane with one or more further pore modifying agents.

In a further embodiment, the invention provides a method wherein the drum comprises a generally cylindrical hollow drum including drain holes extending from outside the drum to inside the drum, and wherein the pore modifying agent, after it contacts the second surface of the membrane, moves from the outside to the inside of drum. In still a further embodiment, the pore modifying agent moves to the inside of the drum, it passes out of the drum through the drum drain holes.

In another embodiment, the invention provides a method wherein the membrane is held in place on the drum by a vacuum.

In certain embodiments, the invention provides a method wherein the porous drum and membrane are immersed into a tank containing a pore modifying agent. In a further embodiment, the method further comprises immersion into a plurality of tanks containing the same pore modifying agents. In another further embodiment, the method further comprises immersion into a plurality of tanks containing distinct pore modifying agents.

In still another embodiment, a pore opening of the second membrane surface, in contact with the pore modifying agent, is modified to a different extent than a pore opening of the membrane surface in contact with the drum. In a further embodiment, the contact of the second membrane surface, with the pore modifying agent, is direct and continuous.

In another embodiment, the invention provides a method wherein the amount of pore modifying agent contacting the membrane is controlled by vacuum pressure, drum rotation, length of exposure, or the viscosity of the pore modifying agent. In certain embodiments, the vacuum pressure ranges from about 0.1 psi to about 25 psi. In other embodiments, the length of exposure ranges from about 0.1 min to about 30 min. In a further embodiment, the length of exposure ranges from about 10 min to about 12 min.

In another embodiment, the viscosity of the pore modifying reagent ranges from about 200 Centipoises to about 1200 Centipoises.

In still another embodiment, the drum is attached to a vacuum, a drive shaft and a drive system. In a further embodiment, the pore modifying agent is drawn from the second surface of the membrane to the first surface of the membrane, through the pores in the membrane, by the vacuum. In another embodiment, the drum is rotated by the drive system. In other embodiments, the drive system is controlled with speed controls.

In certain embodiments, the instant invention methods provide a round porous drum immersed in a holding tank, with the drum center shaft connected to a vacuum source and to a drive system with speed controls. The membrane to be treated is attached to the drum and is held in place by the vacuum, as the drum rotates in response to the speed setting. The holding tank area with the immersed drum is filled with a pore modifying agent or a plurality of pore modifying agents, so that the membrane is contacted with the pore modifying agent(s), wherein the outer surface of the membrane is most contacted with the pore modifying agent(s), and the inner surface of the membrane (in contact with the drum) is contacted with the pore modifying agent(s) to a lesser extent. The flow of pore modifying agent(s) is direct and continuous with constant entrance and exit, so that residual pools of pore modifying agent(s) do not accumulate. In this manner, the pores of the outer surface of the membrane are affected more than the pores of the inner surface of the membrane.

In one embodiment, the invention provides a method wherein the method modifies the membrane pore shape. In certain embodiments, the membrane pores are modified to be cylindrical, funnel shaped, leafy shaped, fibrous in chain fashion, oval shaped, or interwoven pores shape.

In still another embodiment, a pore opening on the second surface of the membrane is wider than a pore opening on the first surface of the membrane. In yet another embodiment, a pore opening on the second surface of the membrane is narrower than a pore opening on the first surface of the membrane.

In one embodiment, the size of the pores at the second surface ranges from about 1.0 μm to about 10.0 μm. In a further embodiment, the size of the pores at the second surface ranges from about 1.0 μm to about 3.0 μm. In another embodiment, the size of the pores on the first surface ranges from about 0.01 μm to about 3.0 μm. In another embodiment, the size of the pores of the second surface is about 10 times to about 1000 times as big as the pores of the first surface.

In another embodiment, the size of the pores at the second surface ranges from about 0.01 μm to about 3.0 μm. In a further embodiment, the size of the pores at the second surface ranges from about 0.2 μm to about 0.45 μm. In another embodiment, the size of the pores on the first surface ranges from about 1.0 μm to about 10.0 μm. In certain embodiments, the size of the pores of the second surface is about 10 times to about 1000 times smaller than the pores of the first surface.

In other embodiments, the invention provides a method wherein the diameter of the pore at the second surface is wider than the diameter of the pore at one or more locations between the first and second surfaces of the membrane.

In another embodiment, the invention provides a method of modifying a porous membrane wherein the thickness of the membrane ranges from about 25 μm to about 500 μm. In certain embodiments, the thickness of the membrane ranges from about 100 μm to about 150 μm.

In another embodiment, the pores comprise about 10% to about 85% of the surface area of the membrane. In a further embodiment, the pores comprise about 50% to about 70% of the surface area of the membrane.

In one embodiment, the invention provides a method of modifying a porous membrane wherein the membrane is selected from the following: polyvinylidene fluoride (PVDF), polyvinyl fluoride (PVF), polytetrafluoroethylene (PTFE), fluorinated ethylene propylene (FEP), polystyrene, polysulfone, polyethersulfone, polyethylene, polyester, Polycarbonates (PC), Polyetheretherketone (PEEK), Polyetherimide (PEI), Polymethylpentene (PMP), Polyphenylene Oxide (PPO), Polyphenylene Sulfide (PPS), Polyvinyl Chloride (PVC), PolyStyrene-Acrylonitrile (SAN), polyolefins (e.g., such as polyethylene or polypropylene), polyester, (e.g., such as Polyethylene Terephthalate (PET) and Polybutylene Terephthalate (PBT)), copolymers of ethylene and tetrafluoroethylene (ETFE), copolymers of ethylene and chlorotrifluoroethylene (ECTFE), copolymers of PVDF with chlorotrifluoroethylene (CTFE); and polyimide, nitrocellulose, Polyacrylonitrile, Polyamide-imide, Aromatic polyamide, Nylon 66, or Cellulose acetate. Preferably, the membrane is polyvinylidene fluoride (PVDF).

In other embodiments, the invention provides a method wherein the pore modifying agent comprises: at least one organic solvent, and at least one pore modifying chemical. In certain embodiments, the organic solvent is selected from: isopropyl alcohol, ethanol, methanol, dimethylformamide, diethyl ether, methyl-tert-butyl ether, benzene, toluene, hexanes, acetone, N-methyl-2-pyrrolidone, tetrahydrofuran, methyl ethyl ketone, dimethylacetamide, tetramethyl urea, dimethyl sulfoxide, methyl isobutyl ketone, cyclohexanone, isobutyl ketone, ethyl acetoacetate, triethyl phosphate, propylene carbonate, glycol ethers, glycol ether esters, and n-butylacetate. In certain embodiments, the organic solvent is isopropyl alcohol.

In other embodiments, the pore modifying chemical consists of ethoxylated (30) bisphenol A diacrylates (CD 9038), 1-hydroxy-cyclohexyl-phenyl-ketone (Irgacure 184), 1-[4-(2-Hydroxy)-phenyl]-2-hydroxy-2-methyl-1-propane-1-one (Ciba Irgacure 2959, benzoin methyl ether; 1-hydroxycyclohexylphenyl ketone; Darocur 1173, tetraethylenepentamine (TEP), tris-(hydroxymethyl)aminomethane (TRIS), sulfuric acid (H₂SO₄), polyethylene glycol (PEG), calcium carbonate (CaCO₃), potassium chloride, Cadmium chloride, nickel chloride or mixtures thereof. In certain embodiments, the surface modifying chemical is a mixture of CD 9038 and Irgacure 184. In certain instances the pore modifying chemical is CD 9038. In other instances the pore modifying chemical is Irgacure 184.

In other embodiments, the pore modifying agent further comprises a viscosity enhancing agent.

In another embodiment, the invention provides of a methods of modifying a porous membrane wherein the pore modifying agent is kept at a temperature of about 20° C. to about 100° C. In certain embodiments, the pore modifying agent is kept at a temperature of about 25° C. to about 85° C.

In another embodiment, the invention provides a method of modifying a porous membrane, further comprising the steps of: curing the modified membrane; washing the modified membrane; and drying the modified membrane.

The modified membranes of the present invention are effective in separating different substances having close particle sizes and can be used for various industrial purposes, e.g. purifying solvents and oils, recovering effective substances from used solvents, treating waste liquids or waste water, purifying sugar liquid, treating proteins and purifying plating liquids; medical applications, e.g. blood filtration and separation of plasma and like uses.

The instant invention provides a method of modifying membrane pores at a fast rate, reduces the amount of pore modifying agent, reduces film in-process tension, reduces film tracking and breaking problems, and reduces the frequency of film wrinkles.

In certain aspects, the invention provides a method wherein a porous round drum or plurality of porous round drums, are wrapped with a membrane around its outside circumference. In certain embodiments, the membrane forms a seal around the drum, which directs the flow of pore modifying agent through the surface of the membrane as the pores are modified. The drum is equipped with a center shaft comprising numerous holes, wherein the holes are designed to access the drum inner surface and provides a means to transport out any air or liquids from inside the drum. In one embodiment, the center shaft is connected to vacuum source which provides a vacuum to the inner surface of the drum.

In other embodiments, the drum or plurality of drums are connected to a drive system comprising speed controls that are capable of rotating each drum. In certain embodiments, each drum comprises additional support hardware, and is immersed into a tank or plurality of tanks that comprise a pore modifying agent.

In some embodiments, each drum vacuum is connected to a center tank for storage of discharges of the pore modifying agent, and a circulating pump that draws the contents of the center tank to a plurality of filters, before returning to the tanks for reuse of said pore modifying agent.

In another embodiment, the porous drums provide support for the membranes while the drum and membrane are connected to a vacuum. In certain embodiments, the membranes are well supported and restricted from movement. While rotating, the membrane is substantially free of torque strain and tension, resulting in a reduction of membrane wrinkles, reduced membrane breakage, reduced dependence on edge guidance, and improved roll stock quality. In certain embodiments, the support provided by the drum and vacuum provides for the production of membranes with large pores from thin membranes, which are beyond the pore size limitations of other methods known in the art. Additionally, the method reduces in-process membrane breakage.

Another advantage of the instant invention is the reduction of required time for membrane modification of pores. Additionally, the instant invention allows for a reduction in the number of rollers and drives that are needed during the process.

### Membranes

Any porous membrane can be modified in accordance with the present invention. Further, any non-porous membranes can first be modified so as to provide pores, followed by modification in accordance with the present invention. Any conventional pore-forming processes can be used.

In one aspect, the invention provides a porous membrane having a first surface and a second surface, comprising a plurality of pores extending between the first and second surfaces, wherein the pores have been modified by a pore modifying agent such that the pore diameter at one or both membrane surfaces is distinct from the pore diameter at one or more locations between the first and second surfaces.

In one embodiment, the invention provides a porous membrane wherein the membrane pores are modified to be cylindrical, funnel shaped, leafy shaped, fibrous in chain fashion, oval shaped, or interwoven pores shape.

In one embodiment, the invention provides a porous membrane wherein the pore modifying agent contacts the pores at the first surface of the membrane for a period of time that differs from contact with the pores at the second surface of the membrane.

In another embodiment, the invention provides a porous membrane the pore modifying agent contacts the pores at the first surface of the membrane at a different concentration than the pores at the second surface of the membrane.

In certain embodiments, the pore modifying agent comprises: at least one organic solvent, and at least one pore modifying chemical. In a further embodiment, the pore modifying chemical consists of ethoxylated (30) bisphenol A diacrylates (CD 9038), 1-hydroxy-cyclohexyl-phenyl-ketone (Irgacure 184), 1-[4-(2-Hydroxy)-phenyl]-2-hydroxy-2-methyl-1-propane-1-one (Ciba Irgacure 2959, benzoin methyl ether; 1-hydroxycyclohexylphenyl ketone; Darocur 1173, tetraethylenepentamine (TEP), tris-(hydroxymethyl)aminomethane (TRIS), sulfuric acid (H₂SO₄), polyethylene glycol (PEG), calcium carbonate (CaCO₃), potassium chloride, Cadmium chloride, nickel chloride or mixtures thereof. In another embodiment, the organic solvent is selected from: isopropyl alcohol, ethanol, methanol, dimethylformamide, diethyl ether, methyl-tert-butyl ether, benzene, toluene, hexanes, acetone, N-methyl-2-pyrrolidone, tetrahydrofuran, methyl ethyl ketone, dimethylacetamide, tetramethyl urea, dimethyl sulfoxide, methyl isobutyl ketone, cyclohexanone, isobutyl ketone, ethyl acetoacetate, triethyl phosphate, propylene carbonate, glycol ethers, glycol ether esters, and n-butylacetate.

In other embodiment, the pore opening at the second surface of the membrane is wider than the pore opening at the first surface of the membrane. In another embodiment, the pore opening at the second surface of the membrane is narrower than the pore opening at the first surface of the membrane.

In one embodiment, the invention provides a porous membrane wherein the size of the pores at the second surface ranges from about 1.0 μm to about 10.0 μm. In a further embodiment, the size of the pores at the second surface ranges from about 1.0 μm to about 3.0 μm. In another embodiment, the invention provides a porous membrane wherein the size of the pores on the first surface ranges from about 0.01 μm to about 3.0 μm. In another embodiment, the size of the pores of the second surface is about 10 times to about 1000 times as big as the pores of the first surface.

In another embodiment, the invention provides a porous membrane wherein the size of the pores at the second surface ranges from about 0.01 μm to about 3.0 μm. In a further embodiment, the size of the pores at the second surface ranges from about 0.2 μm to about 0.45 μm. In another embodiment, the size of the pores on the first surface ranges from about 1.0 μm to about 10.0 μm. In certain embodiments, the size of the pores of the second surface is about 10 times to about 1000 times smaller than the pores of the first surface.

In another embodiment, the diameter of the pore at the second surface is wider than the diameter of the pore at one or more locations between the first and second surfaces of the membrane.

In certain embodiments, the invention provides a membrane wherein the thickness of the membrane ranges from about 25 μm to about 500 μm. In a further embodiment, the thickness of the membrane ranges from about 100 μm to about 150 μm.

In other embodiments, the pores comprise about 10% to about 85% of the surface area of the membrane. Preferably, pores comprise about 50% to about 70% of the surface area of the membrane.

In certain embodiments, the membrane to be modified is selected from the following: polyvinylidene fluoride (PVDF), polyvinyl fluoride (PVF), polytetrafluoroethylene (PTFE), fluorinated ethylene propylene (FEP), polystyrene, polysulfone, polyethersulfone, polyethylene, polyester, Polycarbonates (PC), Polyetheretherketone (PEEK), Polyetherimide (PEI), Polymethylpentene (PMP), Polyphenylene Oxide (PPO), Polyphenylene Sulfide (PPS), Polyvinyl Chloride (PVC), PolyStyrene-Acrylonitrile (SAN), polyolefins (e.g., such as polyethylene or polypropylene), polyester, (e.g., such as Polyethylene Terephthalate (PET) and Polybutylene Terephthalate (PBT)), copolymers of ethylene and tetrafluoroethylene (ETFE), copolymers of ethylene and chlorotrifluoroethylene (ECTFE), copolymers of PVDF with chlorotrifluoroethylene (CTFE); and polyimide, nitrocellulose, Polyacrylonitrile, Polyamide-imide, Aromatic polyamide, Nylon 66, or Cellulose acetate. In a further embodiment, the membrane is polyvinylidene fluoride (PVDF).

In another aspect, the invention provides a kit comprising the porous membrane of the invention, together with instructions for use of the membrane in filtration applications. In one embodiment, the filtration applications are ultrafiltration and microfiltration.

In general, the membranes, pre-modification, are hydrophobic. Most membranes utilized in the invention demonstrate sufficient strength and chemical resistance, and are hydrophobic in nature. A hydrophobic membrane is defined as that membrane which will absorb less than about 0.5% of its weight in water under common hydrophilicity test conditions. A common measure of hydrophobicity of polymers is water absorption by the bulk polymer within 24 hours or at equilibrium as set out in ASTM D570 (standard method to measure water absorption by polymers). For purposes of this invention, a hydrophobic polymer is one absorbing less than 0.5% of its weight of water within 24 hours, and 4% or less at equilibrium. The surface of a solid piece of such a polymer will typically not wet, and a water drop placed on such an inclined surface will roll off without tailing.

Poly(tetrafluoroethylene) Wipe, Polyethylene (PE), Polypropylene (PP) and polyvinylidene fluoride (PVDF) are available hydrophobic membrane materials. Polyvinylidene fluoride (PVDF) is a semi-crystaine polymer containing a crystalline phase and an amorphous phase. The crystalline phase provides good thermal stability whist the amorphous phase has flexibility towards membranes. PVDF exhibits a number of desirable characteristics for membrane applications including thermal resistance, chemical resistance (to a range of corrosive chemicals, including chlorine), and weather (UV) resistance.

In other instances, polyetherimide, polysulfone and polyethersulfone are hydrophobic, while nylon 66, aromatic polyamide are hydrophilic. In addition to those polymers shown above to be hydrophobic, other suitable bulk matrix polymers which are also hydrophobic by the foregoing standard include polyvinyldifluoride (PVDF), and polyimide. In certain embodiments, the polymeric membrane forming material is PVDF, including hydrophobic PVDF.

In another embodiment, the polymeric membrane forming material is polysulfone. The term polysulfone is used herein in the broad sense in which it is understood by those skilled in the art, and is intended to encompass polysulfone per se, as well as the polyether sulfones, polyaryl sulfones (in particular, polyphenyl sulfone), polyalkyl sulfones, polyaralkyl sulfones and the like.

In some embodiments, the surfaces of the porous membranes are hydrophobic. A surface coating material which imparts a hydrophobic character to the surface of the membrane can be used to coat the membranes in some embodiments. By “hydrophobic” it is meant that the surface has a water contact angle greater than about 60°, preferably greater than about 70°. Suitable polymers or biomaterials with surfaces having a water contact angle greater than 70° include, but are not limited to polystyrene (PS), polymethylmethacrylate (PMMA), polyolefins (e.g. polyethylene (PE), polypropylene (PP)), polyvinylchloride (PVC), silicones, polyacrylonitrile (PAN), copolymers of polyacrylonitrile/polyvinal chloride, polysulfone, poly (ether sulfone) (PES), certain polyurethanes, polyesters, polycarbonates, pyrolized materials, and block copolymers containing these constituents.

Lesser hydrophobic polymer surfaces (water contact angles between 60° and 70°), such as PVAC can also be used. Adsorption upon these polymers would be expected to be reduced compared to more hydrophobic polymers such as PS and PMMA. In some cases, detachment of the block copolymer surfactant from the polymer surface over time would be expected. In certain embodiments, these and non-hydrophobic surfaces are treated to render them hydrophobic before copolymer surfactant adsorption. For example, silica can be treated with dimethyl-dichloro silane to provide a hydrophobic surface.

In certain embodiments, a polymer is used to coat the membrane. The polymer used to coat a membrane may be porous or nonporous, or be in the form a flat surface (e.g. a microliter plate), or any suitable shape, such as micro beads, and the like used in chromatography applications. A polymeric surfactant may also be adsorbed upon colloidal or latex particles of a suitable hydrophobic polymer.

On the surface of the membrane, hydrophilic characteristics are achieved by the presence of groups that will attract water molecules. Suitable groups include —OH, —NH, —F, —H or groups with double-bonded oxygen such as carbonyl, sulfonyl or phosphonyl. Electropositive characteristics are achieved by the presence of positively charged atoms. Suitable positively-charged atoms include Si, B or Al. In accordance with the present invention, modified porous membranes are prepared in which the hydrophilic characteristics may be achieved by incorporation of the appropriate hydrophilic groups, and the electropositive characteristics may be achieved by incorporation of appropriate positively-charged atoms. In certain instances, the porous membranes of the present invention have been modified by treatment with trifluoroacetic acid (TFA), BCl₃, SiCl₄, NaOH, F⁻, AlCl₃, alone or in combination, and further with or without treatment with water.

In one aspect, a hydrophobic membrane, such as a PVDF membrane, is modified in accordance with a reagent bath containing a pore modifying chemical. The combination of a reagent bath and pore modifying chemical is understood to be a pore modifying agent. As used herein, “treated” refers to forcing the solution through the membrane for sufficient periods of time to coat the membrane with the pore-modifying chemical and in some cases, a photoinitiator. The bath may further comprise a solvent to facilitate wetting, and to dissolve the pore modifying chemical. A mixture of suitable solvents, such as, for example, a mixture of water with an alcohol, can be included in the bath.

By pore modifying agent, it will be understood to include, but not be limited to, the overall composition of a solution that affects the pores of the porous membrane. In addition, the membrane may be modified with respect to other properties. For instance, a particularly preferred reactivity to be modified is the hydrophilicity/hydrophobicity and/or the surface charge of the membrane. Pore modifying agents have been described above.

A reactivity modifying agent may be incorporated into the membrane in a reacted or unreacted form. The reactivity modifying agent incorporated into the polymeric porous membrane may be subjected to chemical modification subsequent to incorporation into the membrane. One preferred chemical modification is hydrolysis to render the membrane hydrophilic.

Suitable photoinitiators are agents that can initiate radical crosslinking and/or initiate UV curing of the membrane. Such agents are known in the art and include, but are not limited to, 1-[4-(2-Hydroxy)-phenyl]-2-hydroxy-2-methyl-1-propane-1-one (Ciba Irgacure 2959) and other related Irgacures, including 1-hydroxy-cyclohexyl-phenyl-ketone (Irgacure 184); benzoin methyl ether; 1-hydroxycyclohexylphenyl ketone; and Darocur-related molecules, such as Darocur 1173. The membrane is then subjected to crosslinking or an additional treatment which modifies reactivity, such as treatment with one or more of tetraethylenepentamine (TEP), tris-(hydroxymethyl)aminomethane (TRIS), sulfuric acid (H₂SO₄), polyethylene glycol (PEG), calcium carbonate (CaCO₃), potassium chloride, Cadmium chloride, nickel chloride or mixtures thereof. Preferably, exposure to a reagent bath comprising a pore-modifying agent and a photoinitiator is for a period of time from within about 0-10 minutes; longer coating periods may be used but are not necessary. Crosslinking and/or curing can be triggered by actinic radiation, such as, for example, by UV light, or ionizing radiation, such as, for example, gamma radiation or X-radiation. Exposure to actinic radiation can be affected at room temperature for a time usually between about 1 to 120 seconds, and preferably, between about 5 and 60 seconds. Upon completion of crosslinking, the photoinitiator and excess monomer, if present, are removed from the composite porous membrane by rinsing in a suitable solvent, followed by drying.

The pore-modifying agents may form hydrophobic interactions with the substrate membrane via the hydrophobic portion of the agent and form substantially non covalent bonds with the pore (e.g., less than about 1%, and preferably, less than about 0.1%, or less than about 0.01% of the molecules on the membrane are covalently bonded to the pore). Generally, the pore modifying agents also form substantially no ionic bonds with the surface.

The pore-modifying chemicals have integral hydrophobic regions in the molecules which form associations with the membrane pores, facilitating preferential absorption of the pore-modifying molecules on the pore. The hydrophilic portions of the pore-modifying chemicals are extended away from the pores, providing a hydrophilic surface on the membrane while maintaining the underlying porous structure of the membrane.

Pore-modifying agents according to the invention provide one or more of the following properties: resistance to degradation upon exposure to aqueous solutions, such as biological solutions; resistance to degradation by solvents; biocompatibility (e.g., membrane surfaces should not induce significant: platelet adhesion, interfere with the normal clotting mechanism; or cause any significant damage to the cellular elements or soluble components of the blood); and minimal pore clogging. Preferably, membranes comprising pore-modifying chemicals according to the invention are chemically inert.

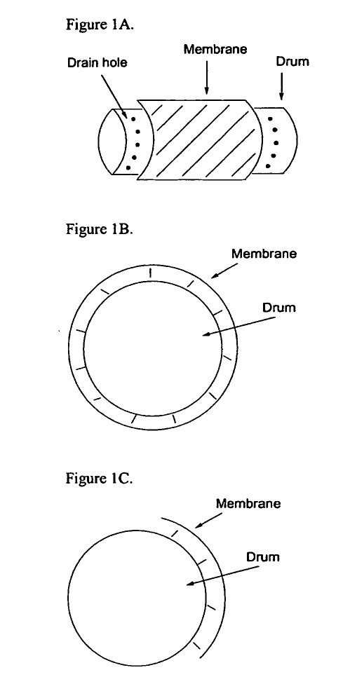

In one embodiment, porous membranes of the present invention are modified on a drum in the presence of one or more surface modifying agents. In particular, a membrane is wrapped about a drum so that a “bottom” surface of the membrane engages the drum, while a “top” surface is not engaged with the drum, for example as shown in FIG. 1. As used herein, the term “top surface” refers to that surface of the microporous membrane that is not engaged with the drum. Conversely, the term “bottom surface” as used herein refers to that surface of the microporous membrane that is engaged with the drum.

The thus modified membranes embrace a family of microporous PVDF membranes that substantially differ from conventional PVDF membranes in their pore size, methanol bubble point, flow rate, and surface area from one side of the membrane compared to the other. The process for making these unique microporous PVDF membranes includes the use of pore modifying agents, e.g., chemicals, solvents, and temperatures that can be varied over a wide range and that are chosen to permit formation of membranes with a variety of structural and functional properties.

Membranes may be characterized by their hydraulic permeability and sieving coefficient. In one aspect, a hydrophobic substrate has a hydraulic permeability for water, at 25° C., of at least about 10.0 ml/m²/hr/cmHg. “Hydraulic permeability” is defined as the volume of a solvent transported through the membrane under the influence of a pressure gradient. In one aspect, hydrophobic substrates according to the invention have an average pore size of from about 0.01 μm to 10 μm, i.e., are suitable for microfiltration. Membranes also can be provided which are suitable for ultrafiltration. Preferably, such membranes have molecular weight cutoff values of 10 kDa or less, 30 kDa, 50 kDa, 100 kDa, or higher. The modified pores may have uniform sizes on average or may comprise varying sizes.

Functional features of membranes of the present invention differ significantly from those of conventional PVDF membranes. Specifically, the present membranes have greater or lesser liquid flow rates per unit area with equal particle retention as compared to conventionally-made PVDF membranes of the same pore size and thickness. This means that if a sample of a solution containing particles is passed through the membrane of the present invention and an equal volume sample of the same solution is passed through a conventional membrane, both membranes will retain the same amount of material, but the membrane of the present invention will have a faster flow rate and process the liquid volume in a shorter time period, the other membrane will have a slower flow rate and process the liquid volume in a longer time period. Membranes of the present invention have a large surface area available at the point of contact between a molecule and the surface of the membrane.

The membranes of the present invention, as compared to conventional membranes exhibit modified flow rates. A comparison between the methanol bubble points and water flow rates of the present membranes and conventional PVDF membranes can be estimated. The water flow rates, in milliliters/minute/square centimeter, of the present finished PVDF membranes (having a broad range of nominal pore sizes) are measured under a pressure of 8 psi.

The methanol bubble points (measured in pounds per square inch above ambient atmospheric pressure) of the present PVDF membranes may or may not be significantly different from the methanol bubble points of conventional PVDF membranes. The term “methanol bubble point” is a well-known check on membrane performance. The bubble point test is based on the fact that liquid is held in the intercommunicating flow channels of microporous membranes by surface tension and that the minimum pressure required to force liquid out of the channels is a measure of the channel diameter. Briefly, a bubble point test is performed by prewetting the membrane with methanol on one side, applying air pressure on the other side of the membrane and watching for air bubbles emanating from the methanol-wetted side to indicate the passage of air through the membrane channels. The pressure at which a steady continuous stream of bubbles appears is the bubble point pressure. It will be appreciated that there may be an inverse relationship between the methanol bubble point and the pore diameter. Thus, for a given thickness of membrane, the higher the methanol bubble point, the smaller the effective pore diameter. The fact that the methanol bubble points are similar between the present membranes and conventional membranes suggests that the increased flow rates of the present membranes may be due to the present membranes having a greater number of flow channels of similar pore diameter or to flow channels with less tortuous configuration (or both) than those of conventional membranes.

The porous membranes of the present invention, including PVDF membranes: (i) encompass a wider range of pore sizes as compared to currently available membranes; (ii) have a flow rate substantially greater than the flow rate of conventionally-made membranes having identical thicknesses and pore sizes; and (iii) have a maximum flow rate (190 ml/min/cm²), for a 2.0 micron nominal pore size membrane, under a pressure of 8 psi, that is not achieved even in a conventional porous PVDF membranes having more than twice the pore size.

A unique aspect of the macrostructure of the present invention is an increased surface area. This is particularly advantageous in applications requiring transfer of one or more molecules to the membrane, since there is a greatly enhanced membrane surface area at the point of contact between a molecule resting on the surface of the membrane and the membrane itself. This is believed to result from the greater amount of surface PVDF in membranes of the present invention than in conventional membranes. Because the surface area of polymer is high at the point of contact between a molecule and the membrane surface, it is believed that sorption of a molecule onto the surface of the present membrane from a target surface or another substrate will be enhanced.

Membranes containing reactive surface groups, such as acid or anhydride groups resulting from the incorporation of pore modifying agents can be crosslinked with crosslinking amines to form amide linkages. The degree of incorporation and extent of crosslinking can be used to construct a membrane suitable for reverse osmosis operations.

In another aspect, a blend of a membrane forming polymer is added to a compatible second polymer, said second polymer being capable of chemical modification after membrane formation. Preferably, the compatible second polymer is compatible with PVDF, or polysulfone, or more preferably, both.

Several studies have been carried out in making asymmetric membranes using small molecular additives to improve membrane characteristics. Such characteristics include high permeability, good macroscopic integrity such as circular lumen, uniform wall thickness, and mechanical strength. It is known from literature that PVDF has a small critical surface tension (about 25 dynes/cm), the coagulation rate and fiber solidification are slow as a result of the weak interaction between the coagulant (water or solvent) and the polymer. As a consequence, difficulties may arise when preparing porous PVDF membranes without additives.

A passive immersion (i.e., dipping, spraying, etc.) may be used to coat the substrate and generate porous composite membranes.

Preferably, the membrane is placed in a flow device (drum) and placed in an immersion bath. A porous modifying agent comprising the difunctional pore-modifying chemicals, solvent, and photoinitiator is forced through a hydrophobic substrate. Solution may be forced through the substrate using a pressure differential, e.g., such as by applying a vacuum and withdrawing the solution into a recycling chamber or waste receptacle. Generally, the flow rate is optimized to achieve satisfactory coating levels (e.g., such as a maximum amount of hydrophilicity at the membrane surface for a minimum amount of pore modifying chemical). The membrane is then exposed to UV light to permit the pore-modifying chemicals to polymerize and to crosslink or cure. The membrane is then dried and can be stored until ready to use.

### Pores

In certain embodiments, the methods of the invention affect membranes with any number of pore sizes, and the methods of the invention are not limited to any such pore sizes. One embodiment of the present invention features a porous membrane. In certain embodiments, the invention features a microporous membrane. The membrane receives fluids under a pressure gradient to define a flow of fluid through the membrane. Thus, because the pore modification agent contacts the pores on each membrane surface to different extends and/or at different concentrations, the membrane pores at each surface are modified to different extends. Embodiments of the present invention have a range of pore sizes and shapes which are unique. Such pore sizes for the first and second surface have been described above, and generally have a nominal pore size ranging from about 0.01 μm to about 10.0 μm.

In one embodiment, the invention provides a porous membrane wherein the membrane pores are modified to be cylindrical, funnel shaped, leafy shaped, fibrous in chain fashion, oval shaped, or interwoven pores shape. Pore shapes include cylindrical, conical, leafy in continuous chain linked, interwoven or funnel shaped, and extended, widened, or constricted at any point along the length of the pore. Such pore shapes encompass pores at either surface of the membrane.

The term “nominal pore size” refers to the minimum size of particles that will be retained on the membrane. Thus, a membrane with a nominal pore size of about 0.45 μm means that particles greater than about 0.45 μm will be retained on the membrane, those less than about 0.45 μm will pass through and will not be retained.

Because of the preferential absorption of surface-modifying molecules on the membrane surface, as well as the preferential absorption of photoinitiators on the membrane surface, crosslinking between polymerized molecules is less likely to form the inter-connecting networks shown and seen for membranes of the prior art, and therefore less pore plugging.

### Solvents

In some embodiments, the present invention utilizes a range of solvent concentrations and temperatures to modify porous membranes of various pore size, polymer symmetry ratio, methanol bubble point, and water flow rate.

The present method uses a single or plurality of solvents. Variation of the operating parameters such as temperature and solvent concentration gives precise control over pore size, polymer symmetry ratio, flow rate, and surface morphology of the pore.

A wide variety of structural and functional properties of the membranes can be achieved in the process by selecting a temperature for either, or both, the mixing solution and formation bath and also selecting a concentration of co-solvent and non-solvent for the pore modifying agent.

Specifically, the temperature of the immersion bath in which the porous membrane is modified, and/or the relative concentration of solvents, can be selected from a range of possible temperatures and solvent concentrations to effect a wide range of structural and functional changes in the pores of the porous membrane. The temperature of the formation bath can be substantially different than the temperature of the initial mixing solution. Indeed the formation bath can be effectively used at temperatures ranging from about 0° C. to about 200° C. In certain embodiments, the temperature ranges from about 20° C. to about 100° C. In a further embodiment, the temperature ranges from about 25° C. to about 85° C.

The term “solvent”, refers to organic compounds that dissolve pore modifying chemicals at most temperatures. Solvents include, but are not limited to, isopropyl alcohol, ethanol, methanol, dimethylformamide, diethyl ether, methyl-tert-butyl ether, benzene, toluene, hexanes, acetone, N-methyl-2-pyrrolidone, tetrahydrofuran, methyl ethyl ketone, dimethylacetamide, tetramethyl urea, dimethyl sulfoxide, methyl isobutyl ketone, cyclohexanone, isobutyl ketone, ethyl acetoacetate, triethyl phosphate, propylene carbonate, glycol ethers, glycol ether esters, and n-butylacetate.

The term “co-solvent” refers to solvents that dissolve pore modifying chemicals slowly at most temperatures. Co-solvents will be known to those of ordinary skill in the art. A representative list includes formamide, methyl isobutyl ketone, cyclohexanone, diacetone alcohol, diisobutyl ketone, ethylacetoacetate, triethyl phosphate, propylene carbonate, glycol ethers, n-butylacetate, water and glycol ether esters. A particularly preferred co-solvent is water.

One aspect of modifying the pores of the present porous membranes is use of solutions comprising a solvent and preferably one or more co-solvents (i.e. a “solvent:co-solvent system”). Because of this, by themselves, many co-solvents are generally unsuitable for the methods of the present invention. They are often unsuitable for the additional reason that they tend to break down polymer, albeit slowly, to such an extent that the membrane cannot reform or coagulate.

This property of a co-solvent, surprisingly, can be utilized in the method of the present invention. An amount of co-solvent added to the solvent permits the solvent:co-solvent mixture to be combined with the membrane polymer. The mixture of the polymer in the solvent:cosolvent is applied at a wide range of temperatures.

A further embodiment of the present invention features a solvent:co-solvent mixture or a co-solvent mixture:non-solvent. The method comprises a co-solvent:non-solvent mixture. The non-solvent is mixable with one or more of the co-solvents and is selected from the group of non-solvents.

In some embodiments, the solvent is methanol or isopropanol. Preferably, the co-solvent:solvent mixture is water and methanol or water and isopropanol. Preferably, the co-solvent is water and comprises about 10 to about 70% of the co-solvent:solvent mixture. In a preferred embodiment, water comprises about 25 to 60% of the co-solvent:solvent mixture. Preferably, water comprises about 52% of the co-solvent:solvent mixture. The solvent is preferably isopropanol, and comprises about 30 to about 90% of the co-solvent:solvent mixture. Preferably, isopropanol comprises about 40 to about 70%, preferably about 46%.

The removal of the co-solvent:solvent mixture is accomplished by washing the porous membrane with water. Preferably, the porous membrane is dried to remove the water.

Preferably, the pore modifying reagent is maintained at a temperature of about 0 to 200° C. Preferably, temperature is selected for a particular desired pore size and solvent:co-solvent system. These methods are known to those of ordinary skill in the art and are considered “routine experimentation.” Thus, by adjusting the heat of the surface modifying reagent, without changing the polymer, solvents and solids, membranes of a variety of pore sizes can be readily manufactured.

The temperature of the polymer:solvent:co-solvent solutions influences the size of the pores. Surprisingly and unexpectedly, the temperature of the formation bath can be maintained at room or low temperatures without influencing the pore size. For any given bath composition, the bubble point is lowered by increasing the temperature of the initial mixing solution.

Preferably, the membranes can be wetted even after drying for at least 2 hours at 90° C. Membrane wetting times range from about 0 to less than a minute, preferably, less than 30 seconds, and still more preferably, in less than about 15 seconds.

### Analysis

A variety of methods are available for the characterization of pores, surfaces and permeability the modified porous membranes of the invention. One method to study adsorption or fouling onto a surface is to use radioactive labels, tagged to the appropriate molecule, however this method has proved too cumbersome. Characterization of the modified membranes is crucial because a small change in one of the membrane production parameters can change the surface structure and consequently have a drastic effect on membrane performance. Structural membrane properties such as pore size and pore size distribution are able to determine which particles or molecules are retained and which will pass through the membrane.

The two techniques primarily used to observe vibrational spectra are infrared (IR) and Raman spectroscopy. The IR spectrum arises from the absorption of radiation, which results from transitions among the various vibrational quantum levels. Infrared testing is carried out primarily on the bulk modified polymer membranes. IR measurements are taken on a polymer membrane with and without the pore modification incorporated into the polymer surface and these two results when compared.

Attenuated Total Reflectance, also known as Internal Reflection Spectroscopy is invaluable in the characterization of surface layers. This technique relies on the intimate contact angle of a sample with the surface of a high refractive index, IR-transparent prism. The basic principles behind this technique is that infrared radiation enters the prism at an angle greater than the critical angle, and is internally reflected at the prism surfaces, but attenuated by absorptions from the sample contact layer.

Primarily, the SEM is an instrument for the examination of surfaces, and is a very convenient, simple technique for characterizing and investigating the porous structure of membranes. The resolution limit of a simple electron microscope lies, in the 0.01 μm range, with more sophisticated microscopes operating at resolutions of 0.005 μm (5 nm). A clear and concise picture of the porous membrane can be obtained in terms of the surface and cross-section, and an estimation of the porosity and pore size distribution can also be obtained.

Many polymers are poor conductors of electricity, and as a result, charge rapidly builds up on the surface of the sample as the electron beam is scanned across it. The resulting field then interacts with the incident electron beam and causes image distortion. This problem can be overcome by coating the sample with a conducting layer usually gold. The gold is applied by sputtering and typical film thicknesses are 20 nm. Sputtering involves creating ions, accelerating them on a target, forming atoms or clusters which are then deposited on the membrane substrate.

The bubble point method is a reflection of the maximum pore size. It is the force needed to drive a liquid through the pores. The liquid used in this case is water, and the gas pressure at which a bubble emerges is measured. The maximum pore size can be calculated from bubble point.

Permeability is a primary factor in governing the performance or efficiency of a porous membrane for water filtration applications is the flow or flux through the membrane. The flux or permeation rate is defined as the volume flowing through the membrane per unit area and time. The equation that describes the flux is: J=Q/A Δt; where Q is the permeated amount, A is the membrane area and Δt the sampling time. The permeability is an important parameter when considering the effect that the pore modifying agent has on the membrane performance.

### Commercial Applications

Microporous membranes of the present invention that are produced in accordance herewith are useful in a number of industries. The composite membranes can be used in a variety of applications, including, but not limited to, liquid separation processes such as microfiltration, ultrafiltration, dialysis, capture and/or immobilization of biomolecules (e.g., nucleic acids, proteins, polypeptides, peptides, viruses, cells, and the like); as surfaces for implantation into the body (e.g., as part of an implantable medical device), or as surfaces incorporated into different devices. Additionally, the membranes can be configured in a variety of forms including, but not limited to, flat sheets, hollow fibers or tubes, and can be any shape.

A useful industrial application of the present membranes is in filtration systems, especially tangential or cross-flow filtration systems. In tangential or cross-flow filtration systems, not all of the liquid volume goes through the membrane. Some fraction of the filtrate volume can be removed and recycled. Tangential flow systems characteristically use tube-shaped filters or cartridges where the flow is moved axially through the tube and material is released transversely across the walls of the tube. Tangential flow can be used at lower pressures than normal filtration and the longevity of the filter is enhanced in this way. Because the flow rates of the membranes of the present invention are significantly faster than those of conventional membranes of equal thickness, tangential flow using the present membranes is particularly advantageous because the time for processing a given volume of sample having a given particle concentration will be much faster than processing using conventional membranes.

The microporous membranes are also useful in the chemical, food and pharmaceutical industries. For instance, one particular use, in filters with pore sizes on the order of about 0.1 μm or less, is the removal of viruses and large macromolecules from the fluids being processed through the membrane. Because PVDF is chemically inert, the membrane may be steamed sterilized repeatedly.

The membrane of the present invention is widely applicable to ultrafiltration through microfiltration. If the size of particles of 90% rejection becomes less than 0.1 μm, the water permeability will tend to decrease; while if the same size exceeds 1 μm, the mechanical strength of the hollow fiber membrane will often decrease. It is therefore desirable that the size of particles of 90% rejection, be in a range of 0.01 to 1 μm.

### EXAMPLES

The invention is further illustrated by the following examples which should in no way be construed as being further limiting.

### Example 1

The flow of treating solution through a porous drum was measured with a membrane disk supported on a porous filter holder. A PVDF 0.45-μm membrane was rendered hydrophilic using the following solution and procedure.

TABLE 1
Treatment Solution Formulations

| Component | g | % |
|---|---|---|
| IPA | 1000 | 46 |
| Water | 1125 | 52 |
| CD 9038 | 35 | 2 |
| Irgacure 184 | 7 | 0.3 |
| Totals | 2167 | 100 |

The membrane was placed onto a filter holder and tightened using sealing bolts. The surface modifying agent of Table 1 was dispensed, at a measured volume, into the holder's inlet. A vacuum pressure of 12 in Hg was maintained and connected to the filter holder. The surface modifying agent of Table 1 was drawn through the membrane disc. The vacuum service was disconnected and removed, and the membrane was attached to a UV rotary frame. The membrane was exposed to UV for 2 minutes. The membrane was washed with DI water and placed into an oven to dry at 90° C. overnight. The results are found in Table 2.

TABLE 2

| | Solution passed | | Wetting time | | Water intrusion | |
|---|---|---|---|---|---|---|
| | (ml) | | (sec) | | (psi) | |
| Membrane # | top | bottom | top | bottom | top | bottom |
| Hydrophobic | | | | | 17 | 17.5 |
| membrane | | | | | | |
| Dry membrane | | | | | | |
| 20 | 200 | 0 | 30 | 235 | 1.0 | 3.0 |
| 21 | 200 | 0 | 10 | 80 | 0.5 | 2.0 |
| 22 | 200 | 40 | 45 | 180 | 1.5 | 2.5 |
| 23 | 200 | 0 | 120 | 360 | 1.0 | 6.0 |
| 24 | 200 | 0 | 420 | 1440 | 4.0 | 10.0 |
| 25 | 100 | 0 | 360 | 1200 | 1.5 | 8.0 |
| 26 | 100 | 0 | 120 | 900 | 2.0 | 8.0 |
| 27 | 200 | 0 | 33 | 240 | 1.0 | 3.0 |
| 28 | 200 | 0 | 12 | 360 | 0.5 | 2.5 |
| 29 | 200 | 0 | 30 | 840 | 1.0 | 4.0 |
| 30 | 100 | 0 | 360 | 780 | 2.0 | 7.0 |

### Example 2

A PVDF 0.45-micron membrane was rendered hydrophilic by the method of example 1. The hydrophilicity of the surfaces were evaluated using water breakthrough pressure. Standard PVDF 0.45 micron membranes were found to have water breakthrough resistance of 1.5 lbs for the hydrophilic membranes and water breakthrough resistance of 28 lbs for hydrophobic membranes. Standard PVDF 0.45 micron membranes made hydrophilic by the new method have water breakthrough resistance of 1.5 lbs on the top side and water breakthrough surface resistance of 4-6 lbs on the bottom side. This surface differential between the two treated surfaces are significant and unique to membranes treated by this new method.

### Incorporation by Reference

The contents of all references (including literature references, issued patents, published patent applications, and co-pending patent applications) cited throughout this application are hereby expressly incorporated herein in their entireties by reference.

### EQUIVALENTS

Those skilled in the art will recognize, or be able to ascertain using no more than routine experimentation, many equivalents of the specific embodiments of the invention described herein. Such equivalents are intended with be encompassed by the following claims.

What is claimed:

1. A method of modifying pores in a porous membrane, the porous membrane comprising pores bridging a first surface and a second surface, the method comprising:
contacting the membrane pores with a pore modifying agent;
wherein the pore modifying agent modifies the pores at the first surface of the membrane differently than the pores at the second surface of the membrane.

2. A method of modifying pores in a porous membrane, the porous membrane comprising pores bridging a first surface and a second surface, the method comprising:
contacting the membrane pores with a pore modifying agent;
wherein the pore modifying agent contacts the pores at the first surface of the membrane at a different concentration than the pores at the second surface of the membrane.

3. The method of claim 1, wherein the pore modifying agent contacts the pores at the first surface of the membrane at a different concentration than the pores at the second surface of the membrane.

4. The method of claim 3, further comprising the step of disposing the membrane on or about a porous drum with the first surface engaging the drum, then contacting the pore modifying agent with the second surface of the membrane.

5. The method of claim 4, further comprising the step of detaching the membrane from the drum, disposing the membrane on one or more further porous drums, and contacting the membrane with one or more further pore modifying agents.

6. The method of claim 4, wherein the drum comprises a generally cylindrical hollow drum including drain holes extending from outside the drum to inside the drum, and wherein the pore modifying agent, after it contacts the second surface of the membrane, moves from the outside to the inside of drum.

7. The method of claim 6, wherein after the pore modifying agent moves to the inside of the drum, passes out of the drum through the drum drain holes.

8. The method of claim 4, wherein the membrane is held in place on the drum by a vacuum.

9. The method of claim 7, wherein the porous drum and membrane are immersed into a tank containing a pore modifying agent.

10. The method of claim 9, further comprising immersion of the drum into a plurality of tanks containing the same pore modifying agents.

11. The method of claim 9, further comprising immersion of the drum into a plurality of tanks containing distinct pore modifying agents.

12. The method of claim 9, wherein a pore opening of the second membrane surface, in contact with the pore modifying agent, is modified to a different extent than a pore opening of the membrane surface in contact with the drum.

13. The method of claim 12, wherein the contact of the second membrane surface, with the pore modifying agent, is direct and continuous.

14. A method of claim 12, wherein the amount of pore modifying agent contacting the membrane is controlled by vacuum pressure, drum rotation, length of exposure, or the viscosity of the pore modifying agent.

15. The method of claim 14, wherein the vacuum pressure ranges from about 0.1 psi to about 25 psi.

16. The method of claim 14, wherein the length of exposure ranges from about 0.1 min to about 30 min.

17. The method of claim 16, wherein the length of exposure ranges from about 10 min to about 12 min.

18. The method of claim 14, wherein the viscosity of the pore modifying reagent ranges from about 200 centripoiese to about 1200 centripoiese.

19. The method of claim 4, wherein the drum is attached to a vacuum, a drive shaft and a drive system.

20. The method of claim 19, wherein the pore modifying agent is drawn from the second surface of the membrane to the first surface of the membrane, through the pores in the membrane, by the vacuum.

21. The method of claim 19, wherein the drum is rotated by the drive system.

22. The method of claim 19, wherein the drive system is controlled with speed controls.

23. The method of claim 1, wherein the method modifies the membrane pore shape.

24. The method of claim 23, wherein the membrane comprises pores shapes that are cylindrical, funnel shaped, leafy shaped, fibrous in chain fashion, oval shaped or interwoven pores shape.

25. The method of claim 24, wherein a pore opening on the second surface of the membrane is wider than a pore opening on the first surface of the membrane.

26. The method of claim 24, wherein a pore opening on the second surface of the membrane is narrower than a pore opening on the first surface of the membrane.

27. The method of claim 25, wherein the size of the pores on the second surface ranges from about 1.0 μm to about 10.0 μm.

28. The method of claim 27, wherein the size of the pores on the second surface ranges from about 1.0 μm to about 3.0 μm.

29. The method of claim 25, wherein the size of the pores on the first surface ranges from about 0.01 μm to about 3.0 μm.

30. The method of claim 25, wherein the size of the pores of the second surface is about 10 times to about 1000 times as big as the pores of the first surface.

31. The method of claim 26, wherein the size of the pores on the second surface ranges from about 0.01 μm to about 3.0 μm.

32. The method of claim 31, wherein the size of the pores on the second surface ranges from about 0.2 μm to about 0.45 μm.

33. The method of claim 26, wherein the size of the pores on the first surface ranges from about 1.0 μm to about 10.0 μm.

34. The method of claim 26, wherein the size of the pores of the second surface is about 10 times to about 1000 times smaller than the pores of the first surface.

35. The method of claim 23, wherein the diameter of the pore at the second surface is wider than the diameter of the pore at one or more locations between the first and second surfaces of the membrane.

36. The method of claim 1, wherein the thickness of the membrane ranges from about 25 μm to about 500 μm.

37. The method of claim 36, wherein the thickness of the membrane ranges from about 100 μm to about 150 μm.

38. The method of claim 1, wherein the pores comprise about 10% to about 85% of the surface area of the membrane.

39. The method of claim 38, wherein the pores comprise about 50% to about 70% of the surface area of the membrane.

40. The method of claim 1, wherein the membrane is selected from the following: polyvinylidene fluoride (PVDF), polyvinyl fluoride (PVF), polytetrafluoroethylene (PTFE), fluorinated ethylene propylene (FEP), polystyrene, polysulfone, polyethersulfone, polyethylene, polyester, Polycarbonates (PC), Polyetheretherketone (PEEK), Polyetherimide (PEI), Polymethylpentene (PMP), Polyphenylene Oxide (PPO), Polyphenylene Sulfide (PPS), Polyvinyl Chloride (PVC), PolyStyrene-Acrylonitrile (SAN), polyolefins (e.g., such as polyethylene or polypropylene), polyester, (e.g., such as Polyethylene Terephthalate (PET) and Polybutylene Terephthalate (PBT)), copolymers of ethylene and tetrafluoroethylene (ETFE), copolymers of ethylene and chlorotrifluoroethylene (ECTFE), copolymers of PVDF with chlorotrifluoroethylene (CTFE); and polyimide, nitrocellulose, Polyacrylonitrile, Polyamide-imide, Aromatic polyamide, Nylon 66, or Cellulose acetate.

41. The method of claim 40, wherein the membrane is polyvinylidene fluoride (PVDF).

42. The method of claim 1, wherein the pore modifying agent comprises: at least one organic solvent, and at least one pore modifying chemical.

43. The method of claim 42, wherein the organic solvent is selected from: isopropyl alcohol, ethanol, methanol, dimethylformamide, diethyl ether, methyl-tert-butyl ether, benzene, toluene, hexanes, acetone, N-methyl-2-pyrrolidone, tetrahydrofuran, methyl ethyl ketone, dimethylacetamide, tetramethyl urea, dimethyl sulfoxide, methyl isobutyl ketone, cyclohexanone, isobutyl ketone, ethyl acetoacetate, triethyl phosphate, propylene carbonate, glycol ethers, glycol ether esters, and n-butylacetate.

44. The method of claim 43, wherein the organic solvent is isopropyl alcohol.

45. The method of claim 42, wherein the pore modifying chemical consists of ethoxylated (30) bisphenol A diacrylates (CD 9038), 1-hydroxy-cyclohexyl-phenyl-ketone (Irgacure 184), 1-[4-(2-Hydroxy)-phenyl]-2-hydroxy-2-methyl-1-propane-1-one (Ciba Irgacure 2959, benzoin methyl ether; 1-hydroxycyclohexylphenyl ketone; Darocur 1173, tetraethylenepentamine (TEP), tris-(hydroxymethyl)aminomethane (TRIS), sulfuric acid (H₂SO₄), polyethylene glycol (PEG), calcium carbonate (CaCO₃), potassium chloride, Cadmium chloride, nickel chloride or mixtures thereof.

46. The method of claim 45, wherein the pore modifying chemical is a mixture of CD 9038 and Irgacure 184.

47. The method of claim 45, wherein the pore modifying chemical is CD 9038.

48. The method of claim 45, wherein the pore modifying chemical is Irgacure 184.

49. The method of claim 42, wherein the pore modifying agent further comprises a viscosity enhancing agent.

50. The method of claim 42, wherein the pore modifying agent is kept at a temperature of about 20° C. to about 100° C.

51. The method of claim 50, wherein the pore modifying agent is kept at a temperature of about 25° C. to about 85° C.

52. The method of claim 1, further comprising the steps of: curing the modified membrane; washing the modified membrane; and drying the modified membrane.

53. A porous membrane having a first surface and a second surface, comprising a plurality of pores extending between the first and second surfaces,
wherein the pores have been modified by a pore modifying agent such that the pore diameter at one or both membrane surfaces is distinct from the pore diameter at one or more locations between the first and second surfaces.

54. The porous membrane of claim 53, wherein the pore modifying agent contacts the pores at the first surface of the membrane for a period of time that differs from contact with the pores at the second surface of the membrane.

55. The porous membrane of claim 53, wherein the pore modifying agent contacts the pores at the first surface of the membrane at a different concentration than the pores at the second surface of the membrane.

56. The porous membrane of claim 53, wherein the pore modifying agent comprises: at least one organic solvent, and at least one pore modifying chemical.

57. The porous membrane of claim 56, wherein the pore modifying chemical consists of ethoxylated (30) bisphenol A diacrylates (CD 9038), 1-hydroxy-cyclohexyl-phenyl-ketone (Irgacure 184), 1-[4-(2-Hydroxy)-phenyl]-2-hydroxy-2-methyl-1-propane-1-one (Ciba Irgacure 2959, benzoin methyl ether; 1-hydroxycyclohexylphenyl ketone; Darocur 1173, tetraethylenepentamine (TEP), tris-(hydroxymethyl)aminomethane (TRIS), sulfuric acid (H₂SO₄), polyethylene glycol (PEG), calcium carbonate (CaCO₃), potassium chloride, Cadmium chloride, nickel chloride or mixtures thereof.

58. The porous membrane of claim 56, wherein the organic solvent is selected from: isopropyl alcohol, ethanol, methanol, dimethylformamide, diethyl ether, methyl-tert-butyl ether, benzene, toluene, hexanes, acetone, N-methyl-2-pyrrolidone, tetrahydrofuran, methyl ethyl ketone, dimethylacetamide, tetramethyl urea, dimethyl sulfoxide, methyl isobutyl ketone, cyclohexanone, isobutyl ketone, ethyl acetoacetate, triethyl phosphate, propylene carbonate, glycol ethers, glycol ether esters, and n-butylacetate.

59. The porous membrane of claim 53, wherein the pore opening at the second surface of the membrane is wider than the pore opening at the first surface of the membrane.

60. The porous membrane of claim 53, wherein the pore opening at the second surface of the membrane is narrower than the pore opening at the first surface of the membrane.

61. The porous membrane of claim 59, wherein the size of the pores at the second surface ranges from about 1.0 μm to about 10.0 μm.

62. The porous membrane of claim 61, wherein the size of the pores at the second surface ranges from about 1.0 μm to about 3.0 μm.

63. The porous membrane of claim 59, wherein the size of the pores on the first surface ranges from about 0.01 μm to about 3.0 μm.

64. The porous membrane of claim 59, wherein the size of the pores of the second surface is about 10 times to about 1000 times as big as the pores of the first surface.

65. The porous membrane of claim 60, wherein the size of the pores at the second surface ranges from about 0.01 μm to about 3.0 μm.

66. The porous membrane of claim 65, wherein the size of the pores at the second surface ranges from about 0.2 μm to about 0.45 μm.

67. The porous membrane of claim 60, wherein the size of the pores on the first surface ranges from about 1.0 μm to about 10.0 μm.

68. The porous membrane of claim 60, wherein the size of the pores of the second surface is about 10 times to about 1000 times smaller than the pores of the first surface.

69. The porous membrane of claim 53, wherein the diameter of the pore at the second surface is wider than the diameter of the pore at one or more locations between the first and second surfaces of the membrane.

70. The porous membrane of claim 53, wherein the thickness of the membrane ranges from about 25 μm to about 500 μm.

71. The porous membrane of claim 70, wherein the thickness of the membrane ranges from about 100 μm to about 150 μm

72. The porous membrane of claim 53, wherein the pores comprise about 10% to about 85% of the surface area of the membrane.

73. The porous membrane of claim 72, wherein the pores comprise about 50% to about 70% of the surface area of the membrane.

74. The porous membrane of claim 53, wherein the membrane is selected from the following: polyvinylidene fluoride (PVDF), polyvinyl fluoride (PVF), polytetrafluoroethylene (PTFE), fluorinated ethylene propylene (FEP), polystyrene, polysulfone, polyethersulfone, polyethylene, polyester, Polycarbonates (PC), Polyetheretherketone (PEEK), Polyetherimide (PEI), Polymethylpentene (PMP), Polyphenylene Oxide (PPO), Polyphenylene Sulfide (PPS), Polyvinyl Chloride (PVC), PolyStyrene-Acrylonitrile (SAN), polyolefins (e.g., such as polyethylene or polypropylene), polyester, (e.g., such as Polyethylene Terephthalate (PET) and Polybutylene Terephthalate (PBT)), copolymers of ethylene and tetrafluoroethylene (ETFE), copolymers of ethylene and chlorotrifluoroethylene (ECTFE), copolymers of PVDF with chlorotrifluoroethylene (CTFE); and polyimide, nitrocellulose, Polyacrylonitrile, Polyamide-imide, Aromatic polyamide, Nylon 66, or Cellulose acetate.

75. The porous membrane of claim 74, wherein the membrane is polyvinylidene fluoride (PVDF).

76. A kit comprising the porous membrane of claim 53, together with instructions for use of the membrane in filtration applications.

77. The kit of claim 76, wherein the filtration applications are ultrafiltration and microfiltration.
